(19) United States
(12) Patent Application Publication
(10) Pub. No.: US 2016/0260150 A1
(43) Pub. Date: Sep. 8, 2016

(54) METHOD AND APPARATUS FOR PROVIDING PATRON-DESIGNED GARMENTS IN A RETAIL STORE

(71) Applicant: Amanda Ackerman, Los Angeles, CA (US)

(72) Inventor: Amanda Ackerman, Los Angeles, CA (US)

(21) Appl. No.: 14/640,952

(22) Filed: Mar. 6, 2015

(51) Int. Cl. G06Q 30/06

(52) U.S. Cl. CPC G06Q 30/0621; G06Q 30/0603; G06Q 30/0641

(57) ABSTRACT

A method for providing one or more garments designed by a retail store patron to customers within the store are described herein. In an embodiment, a garment design program may be accessed using an electronic device provided for use in the store. The garment design program may then receive design specifications from a customer including for example, garment size, material, hardware, embellishment, and other customizable features. When a customer instructs the design program that she is satisfied that her garment includes all desired design specifications, the garment design program publishes the design specifications to a digital catalogue for viewing and optional purchase by other store customers. It then sends the design specifications to a manufacturer that manufactures the garment according to the design specification and provides the garments to a customer in the retail location on the same day that the design specifications are received from the customer.

### GOVERNMENT CONTRACT

Not applicable.

### CROSS-REFERENCE TO RELATED APPLICATIONS

None.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to providing patron-designed garments to customers at a retail location and more particularly, to a system and method for crowd-sourcing customized garment designs which are provided to a customer in the retail location on the same day that the customer places an order for any such garments.

### BACKGROUND

In the past, manufacturers and retailers have allowed their patrons to customize garments by directing a manufacturer or retailer to create garments that deviate from the manufacture's standard measurements so that they better fit the customers' unique bodies. Some manufactures and retailers have also allowed customers to direct them to include additional elements that are not standard features of the merchandise they offer.

These techniques for customization are limited, though, by the need for time and cost efficient production. Because of this, opportunities for consumers to customize the garments they order is often limited to directing a retailer, manufacturer, tailor, and/or seamstress to add appliquéd features and/or screen printed images and phrases their garments. Others may offer tailoring services, which allow a customer to order garments that have been sewn according to specified measurements corresponding to the customer's unique body. Moreover, such techniques involve the remote ordering and production of the customized clothing and thus require the customer to wait as long as many weeks to receive their customized goods.

Thus there is a need for a system and method which allow retail patrons to design all aspects of a garment, publishing such designs for others to view and/or purchase, and also to provide customized garments to a customer on the same day that he or she orders it.

### SUMMARY

The present disclosure is directed to an electronic device and methods for providing retail store patrons with the opportunity to fully design and/or customize their own garments. More particularly, it makes patron-designed garments available for future customers to purchase, and makes any of these customized garments available to retrieve from the store on the same day that they are selected by a customer.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment of the method, an electronic device, such as an Apple iPad®, Microsoft Surface Pro®, or Samsung Galaxy Note® tablet computer, may be provided within a retail store. Of course, it is contemplated that various substitutions and alternatives may be applied to the disclosed embodiments while still reflecting the novel aspects of the invention. For instance, the electronic device may be a personal desktop or laptop computer, or a mobile communications device such as a cell phone or smart phone. The electronic device may be configured to execute a garment design program which is adapted to receive selections related to the design and customization of a garment from any of the store's employees, patrons and/or customers.

In an exemplary embodiment, upon accessing the garment design program, an employee, patron, or customer may be sequentially prompted to make various selections for the program to receive. For example, a program user may be prompted to first select the type of garment they would like to design from a catalogue of garment templates. Such a catalogue might include one or more templates for outerwear, undergarments, lingerie, blouses, shirts, skirts, pants, and any other type of garment that a user might want to design. Each template may further include one or more customizable elements specific to the type of garment represented by the template. For example, the customizable elements available in a shirt template might comprise a front and back side, a collar, a right and left sleeve, one or more breast pockets, a plurality of buttons, as well as the size of each. In another example, the customizable features of undergarments, such as a woman's brassiere, might include underwire, one or more straps, wings, cups, and closure, again as well as the size of each. Of course it is contemplated that the number and nature of customizable elements both offered for customization in the garment design program and received from the customer may be alterable depending on the capability or desire of the retail store to fulfill particular requests, the particular customization wants of a patron and/or customer, and other considerations.

Next, the garment design program may prompt the user to apply one or more design specifications to each of the customizable elements available in the chosen template. The design specifications may relate to any functional features of the garment, such as the size, material, and necessary hardware. The design specifications may also be nonfunctional elements and/or embellishments. In an exemplary embodiment, such non-functional elements and embellishments may include, for example, hem length and/or shape, trim, appliqué, embroidery, and material pattern. Thus returning to the example of the woman's brassiere, upon prompting by the garment design program, a user may select such design specifications as metal underwire, lace straps, and pink cotton fabric having a floral pattern for the cups and wings, each with a size selected to fit her own body.

Having received design specifications relating to each of the customizable elements for the chosen template, the garment design program may then publish the custom designed garment to a digital design catalogue, making them available for future customers to purchase. In an embodiment, this may allow retail stores to efficiently crowd-source garment designs from their customers and other patrons. A patron of a store may be any person or entity who advertises for the store, designs garments sold by the store, or purchases goods for the store. Thus for example, designs created by celebrities or various fashion houses may be published to the digital design catalogue and available for purchase by store customers. In another example, designs created by non-famous, amateur designers and prior customers of the store may be published to the digital design catalogue and available for purchase by future store customers.

In the event that a customer selects a garment from the digital design catalogue, the garment design program may prompt the customer to customize the pre-designed garment. Customizable features of the pre-designed garments may include any or all of those features which defined the customizable elements of the one or more garment templates discussed above. Thus for example, the program may receive instructions to alter the sleeves, material, size, pattern, and any other features of a selected shirt.

In an embodiment, the garment design program may send instructions comprising any user-provided design specifications to a manufacturer to fabricate the customized and designed garment. The manufactured garment may then be received by the retail store and provided to the customer who ordered it.

It is contemplated that the manufacture of the customized and designed garments may be completed within the same business day that any orders for such garments are made at the retail store, although a customer may indicate that he or she would like to retrieve the manufactured garments at a later time. It is moreover contemplated that a customer may retrieve such goods from the store itself, although similarly, a customer may indicate that he or she would like to have the goods delivered to a specified address.

Thus, it is an object of this invention to provide consumers with the opportunity to fully design their own garments.

It is another object of this invention to crowd source garment designs by publishing any which have been created by patrons of a retail store.

It is yet another object of this invention to provide consumers with garments that they have fully designed to reflect their own selected specifications on the same day that the consumers have designed them.

In one embodiment, a user may save any garment designs directly to any galleries built in to their mobile electronic device. In another embodiment, users may upload their garment designs through the Internet to share on existing social media websites. Such sites might include, for example, Facebook® and Twitter®. In yet another embodiment, a user may choose to upload garment designs to a proprietary social platform designated for use in conjunction with the method and apparatus provided for providing patron-designed garments in a retail location.

In accordance with one or more embodiments, an electronic device comprising one or more controllers is also provided. The one or more controllers are configured to perform the functions and operations associated with the above-disclosed method.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a flow diagram illustrating a method for delivering patron-designed garments in accordance with one or more embodiments;

FIG. 2 is an embodiment of a patron-designed garment; and

FIGS. 3A through G are wireframe blueprints showing exemplary embodiments of the display portion of the electronic device as seen by a retail customer.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

### DETAILED DESCRIPTION

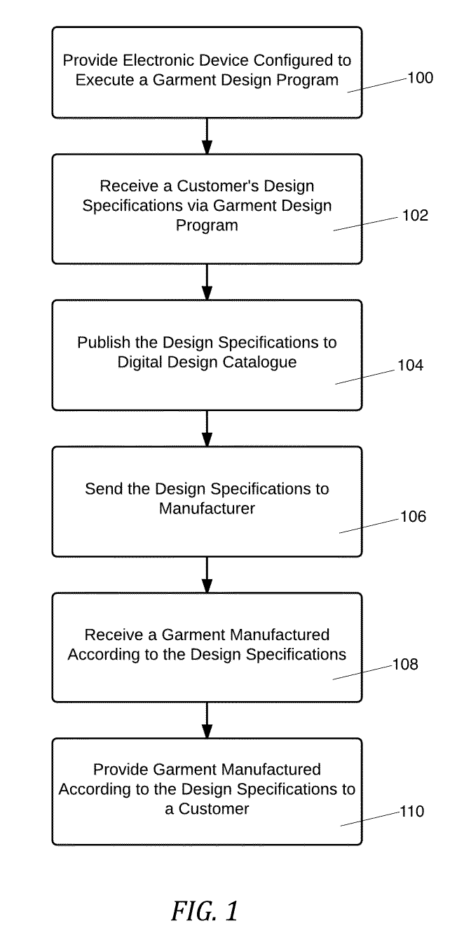

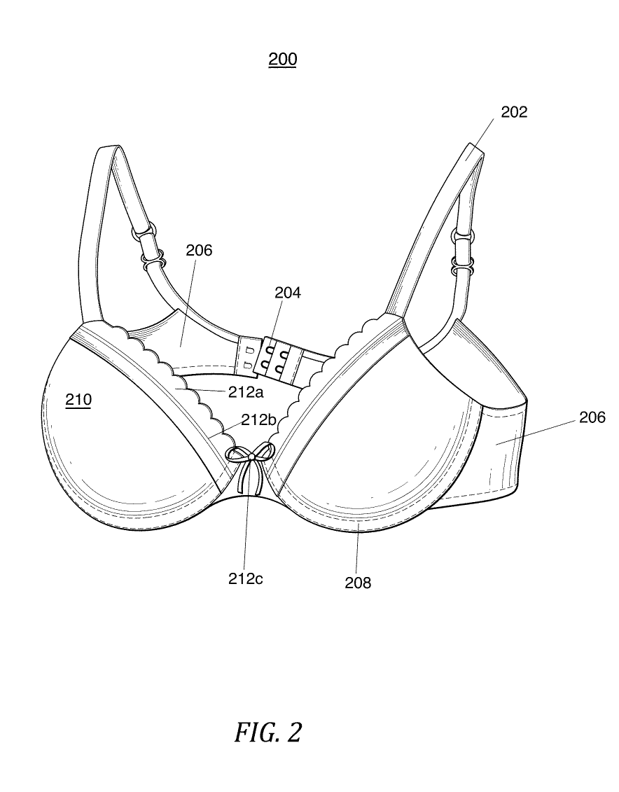

With reference to FIG. 1, a method for providing patron-designed garments, such as that depicted in FIG. 2, to customers of a retail store may begin by first providing an electronic device which is configured to execute a garment design program 100.

The electronic device may be tablet computer. For example, in one embodiment, the retail store may provide one or more tablet computers for their customers, patrons, and/or employees to use. In one embodiment, the one or more tablet computers may be an Apple iPad®. In another embodiment, the one or more tablet computers may be a Microsoft Surface Pro®. In yet another embodiment, the one or more tablet computers may be a Samsung Galaxy Note®. In even another embodiment, it is contemplated that any desktop or laptop personal computer, mobile electronic device or other electronic communications device may be provided which is configured to execute the garment design program 100. In particular, providing the electronic device within a retail store may preserve a customer's retail shopping experience by allowing them to participate in a computer-implemented design process while preserving traditional opportunities to enter storefronts, make purchases in person, and maintain person-to-person communication. However, it is also contemplated that a remote electronic device, such as a home or office personal computer, may also be configured to execute the garment design program.

As the garment design program is being executed by the electronic device, one or more design specifications may be received 102 from a user. In one embodiment, the electronic device may be used by a patron of the store. A patron may be any individual or entity that provides economic support to the store. Thus, for example, a patron may be a customer who purchases or plans to purchase goods for sale by the store. A patron may also be a corporate or celebrity sponsor or advertiser associated with the store. It is also contemplated that the electronic device may be used by a store employee in aid or at the direction of a store patron or human representative of the store itself.

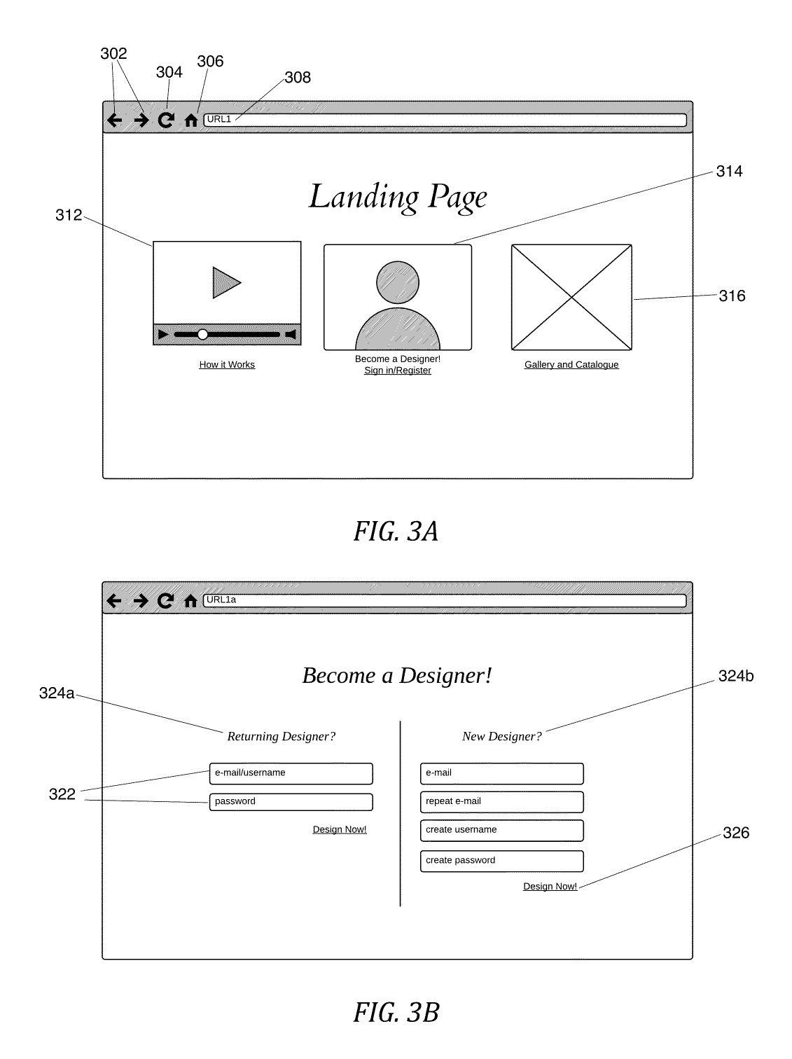

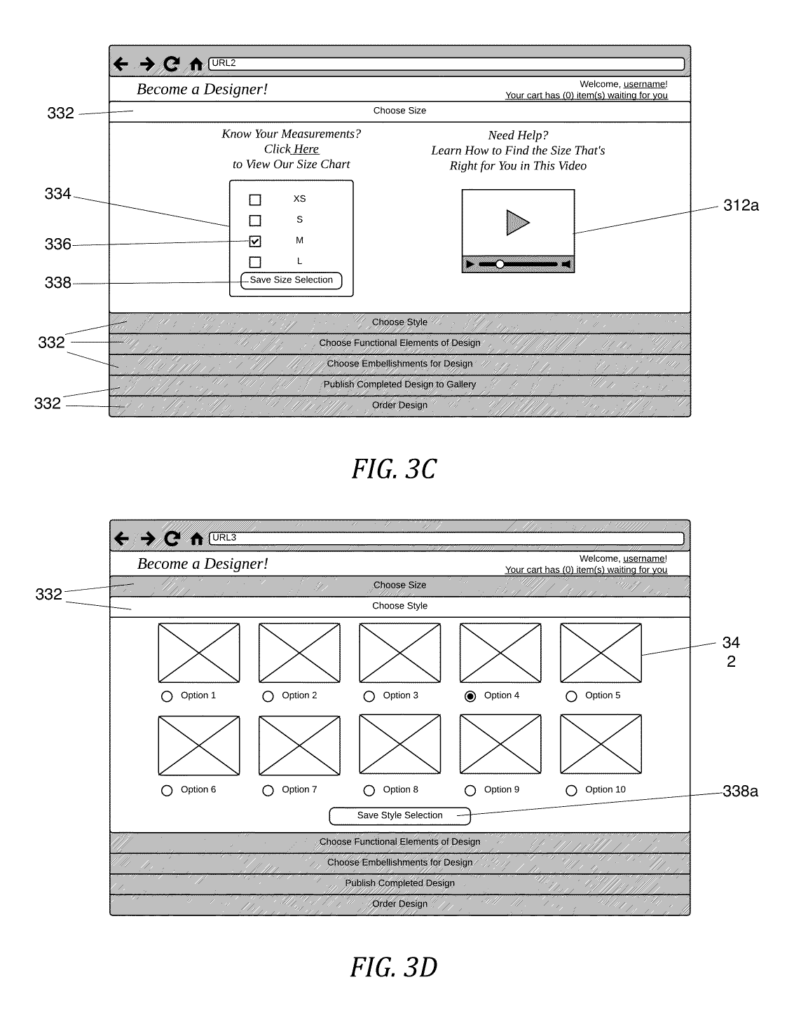

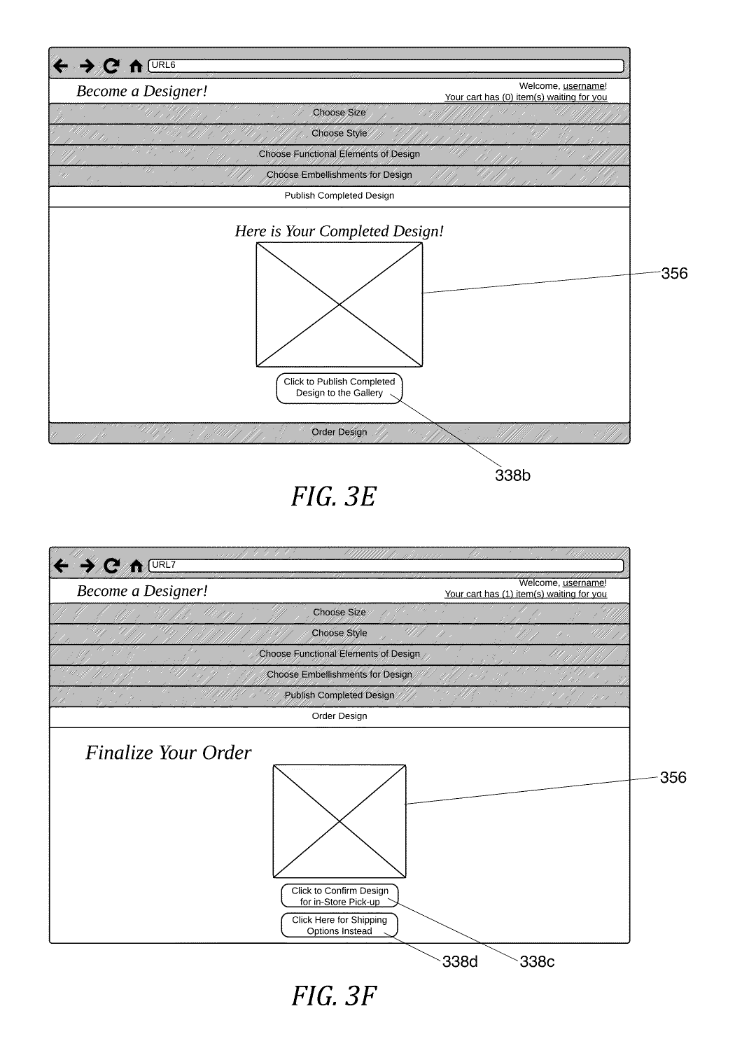

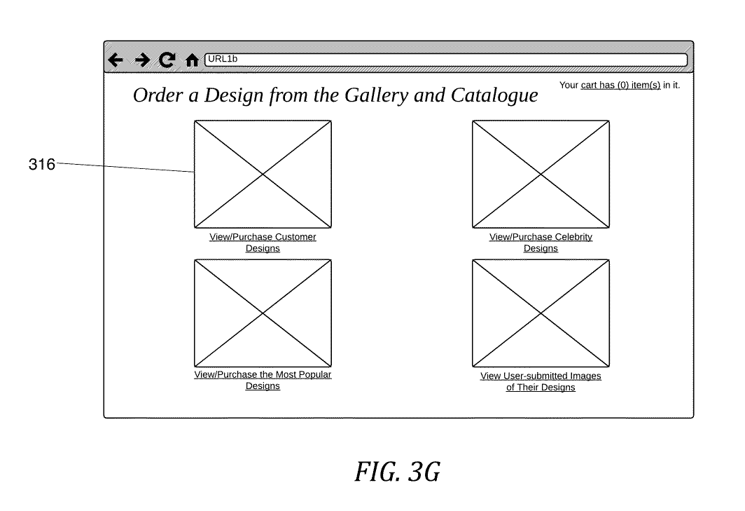

In an exemplary embodiment, the garment design program may sequentially prompt an employee, patron, or customer to make one or more selections which the program is adapted to receive. For example, FIGS. 3A-G show website blueprints, or wireframes, which may be managed by the retail store for the purpose executing the garment design program, accessible to their patrons or customers through the Internet. Of course, such blueprints are provided only for illustrative, rather than limiting, purposes, and the garment design program may take other forms while still embodying the novel features of this invention.

FIG. 3A shows a representative landing page, commonly known as a home or welcome page, within a generic web browser frame. Thus, typical elements of a web browser may be included. A user may be able to navigate any sequential pages of the garment design program using typical browser backward and forward navigation buttons 302. The user may reload the page using a typical refresh button 304, and the user may return to a landing page using a typical home button 304. A space for a user to type in a universal resource locator 308, commonly known as a URL or web address, is also provided for illustration.

The landing page may have introductory material included to acquaint the users with the retail store. In one embodiment, a video tutorial 312 may be provided for the user to learn more about the store. In particular such a video tutorial may instruct the user how to provide his or her design selections for receipt by the garment design program. In another embodiment, a written post detailing the answers to questions frequently asked by store patrons may be provided.

It should be noted that some features in the illustrations, particularly pointed out with reference to the various character references, include generic representations of their content. It is contemplated that any such features provided in the garment design program may be designed to appear in any manner seen fit by the designer, manager, and/or host of the garment design program. In an embodiment, such features may, for example, comprise photographic icons or logos associated with a retail store. Such features may alternatively, or additionally, comprise text or other graphic representations of the content. Such features may even include commercial photographs or user-submitted images of patron-designed garments. Thus, where a frame is provided and crossed through, such as in FIG. 3A at character reference 316, it is contemplated that the garment design program will appear with a visual to prompt a user through the garment design program.

The landing page may also include a prompt for the user to identify him or herself 314 so that any design specifications received from the user are uniquely traceable to him or her. An exemplary identification form is provided in FIG. 3B. In an embodiment, the identification form may be a typical login page. For example, it may prompt different input 322, such as an e-mail address or username and password, from returning or new customers to the store 324a, 324b. It may also provide hyperlink 326 for a user to click, indicating that the user has finished identifying him or herself and is ready to design his or her garment.

Returning to FIG. 3A, the garment design program may alternatively provide the user with the option to access a gallery and catalogue of other patrons' designs 316. In an embodiment, the gallery and catalogue of other patrons' designs 316 may comprise a digital design catalogue of patron designs published by the garment design program and will be discussed with further detail below.

The garment design program may then receive a customer's design specifications 102, with exemplary depictions provided in FIGS. 3C and D, and publish the design specifications to a digital design catalogue 104, with exemplary depictions in FIGS. 3E and G. More particularly, the garment design program may prompt the user to make selections in a series steps, indicated by headings 332 for the purpose of illustration only.

In an exemplary embodiment, the garment design program may prompt a user to indicate the size of the garment that he or she would like to design 334. For example, the garment design program may receive a selection for one from a list of traditional, alphanumeric sizes 336. In another embodiment, a user may be prompted to supply the length, width, and/or height of various body parts to statistically determine the appropriate size of the garment. Additional media 312a may be provided which aids a user in determining the appropriate size to choose. A user may then instruct the garment design to include the chosen size as one of the one or more design specifications to define the final, patron-designed garment. This may be done, for example, by selecting a button 338 or hyperlink.

Sequential progression through the garment design program may continue when the garment design program further prompts a user to select type of garment they would like to design from a catalogue of garment templates. Such templates are illustrated in FIG. 3D as Options 1 through 10 342 under a “style” heading 332. In the illustrated embodiment, the garment template entitled “Option 4” has been selected, as indicated by the filled button. Of course, this representation of the catalogue of garment templates and the selection of a garment template is merely provided to illustrate, rather than limit, the particular form that such a catalogue of garment templates may take. For instance, in one embodiment, a picture of a representative garment may be provided for each garment template. In another embodiment, a written list describing each garment template may be provided.

The catalogue of garment templates might include one or more templates for outerwear, undergarments, lingerie, blouses, shirts, skirts, pants, and/or any other type of garment that might be offered for purchase at a retail store. The number and nature of garment templates indicated by the garment design program may be as many or as few as a retail store sees fit to, or is capable of, offering for patrons to design.

As in FIG. 3D, a user may instruct the garment design to include the chosen garment template as one of the one or more design specifications by, for example, selecting a button 338a or hyperlink.

Each template may further include one or more customizable elements specific to the type of garment represented by the template. The customizable elements of a garment may be either functional or non-functional and may be better understood with reference to FIG. 2.

A customizable woman's brassiere 200 is shown. Functional customizable elements are those which comprise the defining features of a garment. Thus, for example, the functional elements of an undergarment such as the brassiere might include one or more straps 202, a closure 204, winged sides 206, underwire 208, and cups 210. The garment design program may receive instructions from a user to apply one or more design specifications to each of the customizable elements. For example, in one embodiment, the garment design program may receive instructions to apply a specified fabric to the winged sides 206 and cups 210. In another embodiment, the garment design program may receive instructions to apply a specified metal or plastic hardware to either or both of the closure 204 and underwire 208 elements. With respect to the closure 204 in particular, the garment design program may receive instructions to apply a specified hardware chosen, for example, from a zipper, a series of hook and loop fasters (depicted in the illustration), or a mating snap. In yet another embodiment, the garment design program may receive instructions to apply a specified type of strap 202, chosen, for example, from strap configuration (such as convertible to racer-back), and defined by a material of specified elasticity (such as traditional elastic straps or lace).

In another example, functional customizable elements available in a garment template defining a shirt may comprise a front and back side, a collar, a right and a left sleeve, one or more breast pockets, and a plurality of buttons. In an exemplary embodiment, the garment design program may receive instructions to apply user design specifications related to the material and size of each of these elements. It is of course contemplated, however, that the number and nature of customizable elements both offered for customization in the garment design program and received from a user may be alterable depending, for example, on the capability or desire of a retail store to fulfill particular requests, the particular customization wants of a patron and/or customer, and other considerations. Thus, for example, a retail store direct the garment design program not to receive a user design specification to apply a particular type of hardware or material to a customizable feature of a selected garment template.

The design specifications may also be nonfunctional elements and/or embellishments to the patron-designed garment. Nonfunctional elements do not necessarily contribute to the overall utility of the patron-designed garment, but instead relate to the aesthetic design. In an exemplary embodiment, such non-functional customizable elements may include, for example, color, stich shape, hem length and/or shape, trim, appliqué, embroidery, and pattern. Again with reference to FIG. 2, exemplary embellishments are shown as a scalloped trim 212a and stripe 212b along the edges of the cups 210, as well as an appliquéd bow 212c between them.

Thus, in one embodiment, the garment design program may receive instructions to apply a specified print to the fabric chosen for the winged sides 206 and cups 210. In another embodiment, the garment design program may receive instructions to apply specified appliquéd patchwork and/or embroidery to the brassiere 200. Again, the number and nature of customizable nonfunctional elements may be alterable, and the foregoing are provided simply for ease of understanding.

Thus, the garment design program may receive a customer's design specifications 102 until each of the customizable elements available to a chosen template includes one or more design specifications.

Referring to FIGS. 1 and 3E, the garment design program may then publish the completed, custom designed garment 356, defined by the one or more design specifications, to a digital design catalogue 104, making it available for future customers to purchase. As in aforementioned embodiments of the invention, the garment design program may receive instructions to publish the patron-designed garment when a user selects a button 338b or hyperlink.

Publication 104 may allow retail stores to efficiently crowd-source garment designs from their patrons. Thus, for example, designs created by celebrities, professional designers, and/or various fashion houses may be published to the digital design catalogue and available for purchase by store customers. In another example, designs created by non-famous, amateur designers and/or prior customers of the store may be published to the digital design catalogue and available for purchase by future store customers.

As discussed above with reference to FIG. 2, and now with reference to FIG. 3G, the garment design program may alternatively provide the user with the option to access a gallery and catalogue of other patrons' designs 316, which may comprise the digital design catalogue. In the event that a customer chooses to order a garment previously designed by a retail store patron, the garment design program may prompt the customer to customize the pre-designed garment. Customizable elements of the pre-designed garments may include any or all of those elements which defined the customizable elements of the one or more garment templates discussed above. Thus for example, the program may receive instructions to conform the selected, pre-designed garment to a specified size. The program may additionally receive instructions to alter, for example, the sleeves, material, size, pattern, and any other features of a selected shirt. With respect to an exemplary brassiere, the program may receive instructions to alter the size, hardware, material, pattern, and any other features included in a pre-designed brassiere.

Whether the patron-designed garment has been altered from a pre-designed garment, or one built upon a garment design template, the garment design program may receive instructions to finalize and place an order with the retail store for the custom designed garment. In an embodiment, such instructions may also cause the garment design program to send any user-provided design specifications to a manufacturer 106 so that the patron-designed garment may be fabricated. Once fabricated, the manufactured garment may then be received by the retail store 108 and provided to the customer who ordered it 110.

It is contemplated that the manufacture of the customized and designed garments may be completed within the same business day that any orders for such garments are made at the retail store. Indeed, as illustrated in FIG. 3F, the garment design program may receive instructions to provide the garment for in-store pick-up when a customer selects button 338c. Alternatively, a customer may indicate that he or she would like to retrieve the manufactured garments at a later time. It is also contemplated that a customer may instruct the garment design program to direct delivery of the patron-designed garment to a specified address other than the retail store 338d.

In an embodiment, the invention may be implemented by a program product for use with a computer system. The program(s) of the program product may define functions of the embodiments (including the methods described herein) and can be contained on a variety of computer readable storage media. For the purposes of this description, a computer-readable medium can be any apparatus that can contain, store, communicate, propagate or transport the program for use by or in connection with the instruction execution system, apparatus or device.

Illustrative computer-readable media may be an electronic, magnetic, optical, electromagnetic, infrared, or semiconductor system (or apparatus or device) or a propagation medium. Examples of such computer-readable media include but are not limited to: (i) non-writable storage media on which information is permanently stored, for example, read-only memory devices within a computer, such as CD-ROM disks readable by CD-ROM drive; (ii) writable storage media on which alterable information is stored, for example, floppy disks within a diskette drive or hard-disk drive. Such computer-readable instructs that direct the functions of the present invention are embodiments of the present invention.

Other media may include communications media through which information is conveyed to a computer, such as through a computer or telephone network, including wireless communications networks. Such wireless communications networks may specifically include the transmission of information to and/or form the Internet and other networks. Such communications media, when carrying computer-readable instructions directing the functions of the invention are embodiments of the invention. Thus, broadly, computer-readable storage media and communications media may be referred herein as computer-readable media.

In general, the routines executed to implement the embodiments of the invention may be part of an operating system or a specific application, component, program, module, object, or sequence of instructions, the computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### CONCLUSIONS, RAMIFICATIONS, AND SCOPE

While certain embodiments of the invention have been illustrated and described, various modifications are contemplated and can be made without departing from the spirit and scope of the invention. For example, although a customizable woman's brassiere has been discussed with particularity above, it is provided only as an example of the types of garments contemplated as objects of this invention. Indeed, it is contemplated that the disclosed method and system may be employed to allow retail patrons to custom design all manner of apparel. The realm of customizable garments available to this disclosure may include, but is not limited to: jackets, sweaters, vests, sweatshirts, shirts, blouses, dresses, pants, shorts and/or skirts; outerwear and/or undergarments; clothing appropriate for athletics, swimming, formal occasions, casual occasions, lounge, sleep and/or vacation; and even accessories such as hats, mittens, gloves, socks, and/or gloves may be custom designed and provided as described. Similarly, the number and extent of customizable elements of any or all of the customizable garments may vary depending on various factors such as supply and demand in the marketplace. The system and method may be employed to custom design for children and either or both of men and women of any age. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the method and apparatus for providing patron-designed garments in a retail location with which that terminology is associated. In general, the terms used in the following claims should not be constructed to limit the method and apparatus to the specific embodiments disclosed in the specification unless the above description section explicitly define such terms. Accordingly, the actual scope encompasses not only the disclosed embodiments, but also all equivalent ways of practicing or implementing the disclosed method and apparatus. The above description of embodiments of the method and apparatus for providing patron-designed garments in a retail location is not intended to be exhaustive or limited to the precise form disclosed above or to a particular field of usage.

While specific embodiments of, and examples for, the method and apparatus are described above for illustrative purposes, various equivalent modifications are possible for which those skilled in the relevant art will recognize.

While certain aspects of the method and apparatus disclosed are presented below in particular claim forms, various aspects of the method and system are contemplated in any number of claim forms. Thus, the inventor reserves the right to add additional claims after filing the application to pursue such additional claim forms for other aspects of the method and apparatus for providing patron-designed garments in a retail store.

What is claimed is:

1. A method for providing patron-designed garments in a retail location, comprising:
accessing a garment design program adaptable for execution on an electronic device;
receiving one or more design specifications;
publishing the one or more design specifications to a digital design catalogue;
sending the one or more design specifications to a manufacturer;
receiving a garment manufactured according to the one or more design specifications sent to the manufacturer; and
providing the garment manufactured according to the one or more design specifications to a customer in a retail location on the same day that the one or more design specifications is received.

2. The method of claim 1, wherein the electronic device provided is for use within the retail location

3. The method of claim 2, wherein receiving design specifications further comprises the steps of:
providing a catalogue of garment templates, each template including one or more customizable elements;
receiving a template selection; and
receiving instructions to apply one or more design specifications to each of the one or more customizable elements until each customizable element includes at least one design specification.

4. The method of claim 3, wherein the execution of the garment design program controls sequential operation of the providing and receipt steps of receiving design specifications.

5. The method of claim 1, wherein the electronic device is a tablet computer.

6. A method for providing patron-designed garments in a retail location, comprising:
providing a catalogue of patron-designed garments;
accessing the catalogue via a garment design program adaptable for execution on an electronic device;
receiving a selection of one of the patron-designed garments provided in the catalogue;
receiving one or more instructions to customize the selected patron-designed garment;
sending the selected patron-designed garment and one or more instructions to customize the selected patron-designed garment to a manufacturer;
receiving a garment manufactured according to the one or more instructions to customize the selected patron-designed garment; and
providing the patron-designed garment manufactured according to the one or more instructions to customize the selected patron-designed garment to a customer in a retail location on the same day that the one or more instructions to customize the selected patron-designed garment is received.

7. The method of claim 6, wherein the electronic device is provided for use within a retail location.

8. The method of claim 7, wherein the execution of the garment design program controls sequential operation of the receiving the selection of one of the patron-designed garments provided in the catalogue, receiving the one or more instructions to customize the selected patron-designed garment, and sending the selected patron-designed garment and the one or more instructions to customize the selected patron-designed garment to a manufacturer.

9. The method of claim 6, wherein the one or more instructions to customize the selected patron-designed garment comprises at least an instruction to manufacture the selected patron-designed garment in a chosen size.

10. The method of claim 6, wherein the electronic device is a tablet computer.
